(19) United States
(12) Patent Application Publication
(10) Pub. No.: US 2025/0216155 A1
(43) Pub. Date: Jul. 3, 2025

(54) AUTOMATIC CALIBRATION OF A DENTAL FURNACE

(71) Applicant: Ivoclar Vivadent AG, Schaan (LI)

(72) Inventors: Gregor BECK, Schaan (LI); Tarkan CETIN, Feldkirch (AT); Rudolf JUSSEL, Feldkirch-Gisingen (AT)

(21) Appl. No.: 18/989,250

(22) Filed: Dec. 20, 2024

(30) Foreign Application Priority Data
Dec. 27, 2023 (EP) 23220304.2

(51) Int. Cl. F27B 17/02; A61C 13/083; F27D 19/00; F27D 21/02; G06T 7/00; G06T 7/62

(52) U.S. Cl. CPC F27B 17/025; A61C 13/083; F27D 19/00; F27D 21/02; G06T 7/001; G06T 7/62; F27D 2019/0071; F27D 2021/026; G06T 2207/30036

(57) ABSTRACT

A dental furnace (100) for sintering dental objects, having a detection device (103) for detecting a dimension of a sintered reference body (105) and a parameter determination device (107) for determining a process parameter for a sintering process on the basis of the detected dimension.

### CROSS-REFERENCE TO RELATED APPLICATIONS

This application claims priority to European Patent Application No. 23220304.2 filed on Dec. 27, 2023, the disclosure of which is incorporated herein by reference in its entirety.

### TECHNICAL FIELD

The present invention relates to a dental furnace for sintering dental objects and a method of sintering dental objects.

### BACKGROUND

PTC rings (process temperature control rings) are currently used to calibrate dental furnaces. These are sintered in the firing chamber of the dental furnace with predefined process parameters and experience a temperature-dependent shrinkage during this process, which is noticeable in the reduction of the spatial shape. After a firing process inside the dental furnace, the diameter of the PTC ring can be measured and compared with a corresponding table. This can be used to determine a more precise process parameter for the sintering process inside the dental furnace.

However, there are several sources of error that can lead to incorrect calibration. For example, the PTC ring may be incorrectly arranged in the dental furnace or the diameter of the fired PTC ring may be measured by the user at an incorrect point. The measurement using a caliper gauge or a micrometer screw can be carried out incorrectly by the user or an incorrect table can be used to read the process parameter. This can result in reading errors from the table or errors when manually transferring the determined calibration values to the dental furnace. This process is also time-consuming.

### SUMMARY

It is therefore the technical task of the present invention to simplify and accelerate a calibration of a sintering process in a dental furnace.

This task is solved by subject-matter according to the independent claims. Advantageous embodiments are the subject-matter of the dependent claims, the description and the figures.

According to a first aspect, the technical task is solved by a dental furnace for sintering dental objects, comprising a detection device for detecting a dimension of a sintered reference body; and a parameter determination device for determining a process parameter for a sintering process on the basis of the detected dimension. The detection device and/or parameter determination device can be integrated directly into the dental furnace or can also be connected wirelessly to the dental furnace as individual units via a data connection, such as via WLAN or Bluetooth. In general, several dimensions of the sintered reference body can also be detected by the detection device. A shape or volume of the unsintered reference body can then be determined on this basis. The process parameter can comprise a direct physical value with which the sintering process is carried out, or a correction value for a preset physical value with which the sintering process is carried out.

The dental furnace achieves the technical advantage that process parameters can be set optimally and automatically on the basis of the dimension of the sintered reference body. Setting steps are automated and potential sources of error are eliminated.

In a technically advantageous embodiment of the dental furnace, the detection device comprises a camera or a scanning device. This achieves the technical advantage, for example, that the dimension of the reference body can be determined with a high degree of accuracy. In addition, the spatial shape or volume can also be determined by the detection device.

In a further technically advantageous embodiment of the dental furnace, the detection device is arranged in such a way that the reference body can be detected inside the dental furnace. For example, the reference body is detected on a storage surface inside the dental furnace. This achieves the technical advantage, for example, that the sintered reference body does not have to be moved out of the dental furnace.

In a further technically advantageous embodiment of the dental furnace, the detection device is configured to determine a volume of the reference body or a shape of the sintered and/or unsintered reference body. This achieves the technical advantage, for example, that deviations before and after sintering of the reference body can be determined with even greater accuracy.

In a further technically advantageous embodiment of the dental furnace, the detection device is configured to detect a type of the reference body. The type can be detected, for example, on the basis of a scannable code that is arranged on the reference body. This achieves the technical advantage, for example, that the properties of the reference body can be determined.

In a further technically advantageous embodiment of the dental furnace, the detection device is configured to determine the dimension of the unsintered reference body on the basis of the type. For example, the dimensions of the reference body are retrieved from a table or database on the basis of the type. This achieves the technical advantage, for example, that the unsintered reference body does not need to be detected in advance.

In a further technically advantageous embodiment of the dental furnace, the detection device is configured to identify whether the reference body is arranged in a predetermined area. This achieves the technical advantage, for example, that a correct arrangement of the reference body is checked and a possible source of error is automatically identified and eliminated.

In a further technically advantageous embodiment of the dental furnace, the parameter determination device is configured to determine the process parameter on the basis of a difference between the dimension of the unsintered reference body and the dimension of the sintered reference body. This achieves the technical advantage, for example, that the accuracy of the determination of process parameters is further improved.

In a further technically advantageous embodiment of the dental furnace, the parameter determination device is configured to determine a process parameter for a temperature, a temperature profile, a duration of the sintering process, a calibration value for a preset process parameter, and/or an air pressure value in the firing chamber. This achieves the technical advantage, for example, that the dental furnace can set or calibrate particularly suitable process parameters.

In a further technically advantageous embodiment of the dental furnace, the dental furnace comprises a holder for receiving and measuring the reference body. This achieves the technical advantage, for example, that the reference body can be detected with high accuracy at an intended location.

According to a second aspect, the technical task is solved by a method of sintering dental objects, comprising the steps of detecting a dimension of a sintered reference body by a detection device; and determining a process parameter for a sintering process on the basis of the detected dimension. The method achieves the same technical advantages as the dental furnace according to the first aspect. The method can be performed to calibrate the dental furnace. In this case, the process parameter comprises a correction value for a previous process parameter for the sintering process that has been performed on the reference body. The correction value is used to correct the previous process parameter. If the sintering process has been performed on the reference body at a preset temperature, for example, a correction value can be determined as a process parameter with which the preset temperature is adjusted. Alternatively, a corrected and adjusted temperature value can also be determined as a process parameter.

In a technically advantageous embodiment of the method, the reference body is cylindrical, annular or cuboidal. This achieves the technical advantage, for example, that the dimension can be easily determined.

In a further technically advantageous embodiment of the method, the dimension of the unsintered reference body is detected. This achieves the technical advantage, for example, that a change in the dimension due to the sintering process can be determined.

In a further technically advantageous embodiment of the method, the process parameter is determined on the basis of a difference between the dimension of the unsintered reference body and the dimension of the sintered reference body. This achieves the technical advantage, for example, that the process parameter can be determined more accurately.

In a further technically advantageous embodiment of the method, a volume of the reference body or a shape of the sintered and/or unsintered reference body is detected by the detection device. This achieves the technical advantage, for example, that the accuracy of the method is improved even further.

U.S. Pat. Nos. 10,041,734B2, 9,480,544B2, 9814550B2, 20150010876A1, 2009041086A1, and 20040247013A1 are directed to dental furnaces and are hereby incorporated by reference in their entirety.

### BRIEF DESCRIPTION OF THE DRAWINGS

Exemplary embodiments of the invention are shown in the drawings and are described in more detail below, in which:

FIG. 1 shows a schematic view of a dental furnace with a detection device; and

FIG. 2 shows a block diagram of a method of sintering dental objects.

### DETAILED DESCRIPTION

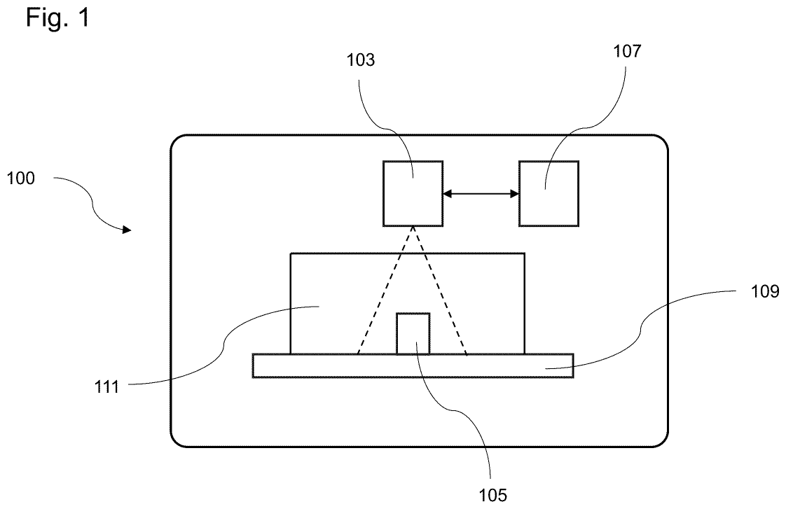

FIG. 1 shows a schematic view of a dental furnace 100 with a detection device 103. The dental furnace is used to produce dental objects by a sintering process, such as crowns, bridges or other dental restorations. The dental objects are heated in a firing chamber 111 of the dental furnace 100 for a predetermined time and temperature so that the intended sintering process can take place. For this purpose, the air pressure in the firing chamber can be lower than in the external environment.

During sintering, fine-grained ceramic or metallic materials of the sintering material used are heated. However, the temperature is below the melting temperature of the main components so that the original spatial shape of the dental object remains essentially unchanged. Depending on the process parameters and sintering materials used, a spatial shrinkage of the dental objects takes place.

To calibrate and determine parameters for a sintering process, reference bodies 105 with a defined geometry, dimensions and properties are used, which are also formed from sintering materials. These reference bodies 105 are, for example, ring-shaped or cuboidal. In general, the reference bodies 105 can also have any other geometry.

With this reference body 105, a sintering process with predefined parameters is first performed inside the dental furnace 100. Depending on the shrinkage of the reference body 105, the other process parameters can be adjusted. If, for example, the shrinkage of the reference body 105 is too great, a previous temperature of the sintering process can be reduced by a correction value, which also forms a process parameter.

For this purpose, the reference body 105 is automatically measured after the sintering process with the predefined parameters by the detection device 103, for example optically with a camera or an intraoral scanner. By doing this, one or more dimensions of the sintered reference body 105 can be detected automatically. For this purpose, the reference body 105 can be detected after a cooling phase inside the dental furnace 100, for example on a storage table or plate inside the firing chamber 111. However, the reference body 105 can also be arranged in a suitable holder 109 after the sintering process, in which the detection device 103 can detect the reference body 105.

Manual errors are eliminated during automatic detection and measurement. The shape, the volume or one or more dimensions of the reference body 105 can be determined by the detection device 103. The dimensions can be given, for example, by an inner or outer diameter of an annular reference body 105 or the edge length of a cuboidal reference body 105.

The detection device 103 can determine the dimension, the volume of the reference body 105 or the shape of the sintered and/or unsintered reference body 105. The detection device 103 is thus able to detect the reference body 105 before and/or after the sintering process, so that changes due to the sintering process can be determined. The detection device 103 is configured, for example, to identify whether the reference body 105 is arranged in a predetermined area, such as, for example, in a designated area on the storage surface inside the dental furnace 100. Appropriate image recognition algorithms can be used for this purpose.

In general, the detection device 103 may be any device that can be used to determine the two- or three-dimensional shape, volume, or one or more dimensions of the reference body 105. For example, the detection device 103 may comprise a camera with or without a size reference, a stereoscopic camera, a lidar scanner, a tactile measurement system, a light measurement system with projected patterns or detected shadows, an interference measurement, or a combination of the processes mentioned.

The detection device 103 can also detect if the reference body 105 has been placed in the wrong position in the dental furnace 100 during sintering. In this case, for example, a geometric distortion of the reference body 105 occurs due to a temperature difference. The dental furnace 100 can also have a special holder 109 for receiving and measuring the reference body 105.

The detection device 103 with a camera on the basis of optical images can, for example, identify the reference body 105 in the captured digital image and determine the dimensions or volume of the reference body 105 based on the size taken in the image. For this purpose, software of the detection device 103 evaluates the geometry of the reference body 105 and measures it automatically. The software is formed, for example, by suitable image recognition software. The geometry can be determined not only at one point (as with a two-point measurement), but all the way around and completely. By analyzing the image, the software can, for example, detect the dimensions, shape or volume of the reference body in the captured image.

The software can also detect a label or a code, for example a barcode or QR code, on the reference body 105 and load corresponding parameters, such as a parameter table for determining a calibration value. Here, for example, the detected code is used to retrieve the data of the reference body 105 from a provided database. The dimensions and geometric shape of the reference body can also be determined on the basis of the code, for example by retrieving them from a database as a function of the code.

The dental furnace 100 comprises a parameter determination device 107 for determining the process parameter for a sintering process on the basis of the detected dimension of the reference body 105, which is also formed by the software. The parameter determination device 107 is configured, for example, to determine the process parameter for the further sintering process on the basis of a difference between the dimension of the unsintered reference body 105 and the dimension of the sintered reference body 105. However, the parameter determination device 107 can also be configured to determine the process parameter for the further sintering process on the basis of an absolute value of the determined dimension of the reference body 105. Depending on the shrinkage of the reference body 105, process parameters can therefore be adapted or selected. This increases the quality of the sintering process and better results are achieved.

The parameter determination device 107 determines, for example, a process parameter for a temperature, a temperature profile, a duration of the sintering process, an air pressure value in the firing chamber or a calibration value for a preset process parameter, i.e. the process parameter can also be formed by a correction value that is applied to a previously set process parameter.

To determine the process parameter, the parameter determination device 107 uses the digital absolute value for the dimension and retrieves a corresponding value for the respective process parameter or a correction value from a correspondingly stored table or database. For this purpose, a relative value can also be used in a corresponding manner, which indicates the change in the dimension of the reference body 105 due to the sintering process. Absolute or relative values that indicate the spatial shape or volume of the reference body 105 can also be used for this purpose.

The parameter determination device 107 can also comprise a self-learning or trained algorithm that uses the digital relative or absolute value for the dimension of the reference body 105 as input and provides the process parameter that is assigned to the dimension as output. For example, an artificial neural network can be used for this purpose, which has previously been taught with corresponding training data for this purpose.

In general, the parameter determination device 107 can be formed by any device with which it is possible to automatically find the respective process parameter for the detected dimension of the reference body.

The software automatically transfers the determined process parameter to the dental furnace 100. The process parameter can be displayed by the software so that the user can enter or check it on the dental furnace 100. The detection device 103 can also be connected to the dental furnace 100, for example internally or via a network, so that the determined process parameter can be automatically transferred to the dental furnace 100. The determined process parameter is then used for the further sintering process.

The software can be executed by a computer with which the detection device 103, the parameter determination device 107 and/or the dental furnace 100 are controlled. However, the software can also be executed by a control unit which is integrated in the dental furnace. The software is executed by a suitable processor which has access to a digital memory. The software and associated data are stored in the digital memory. The software and the detection device 103 can be connected to each other in the same network or via the Internet.

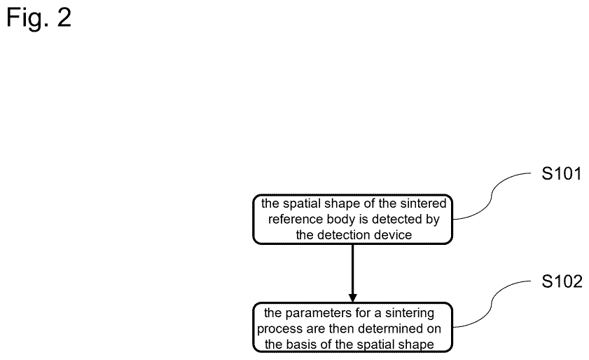

FIG. 2 shows a block diagram of a method of sintering dental objects 100. In step S101, the spatial shape of the sintered reference body 105 is detected by the detection device 103. Only individual dimensions of the reference body 105 can be determined or an entire three-dimensional, spatial area of the reference body.

In step S102, the parameters for a sintering process are then determined on the basis of the spatial shape. Here, a deviation of the reference body can be determined on the basis of a shape of the reference body 105 before the sintering process and a shape of the reference body 105 after the sintering process.

The shape before the sintering process can, for example, also be determined by the detection device 103 or retrieved from a table on the basis of a type of the reference body. If the reference body 105 is measured before the sintering process, an existing deviation of the geometry of the reference body in the unsintered state can be determined.

The dental object is then produced using the newly determined process parameters for the sintering process. The method automates many process steps and eliminates sources of error in the sintering process. The method can be carried out in a short time and increases the quality of a calibration. For example, a measurement of the reference body 105 and a comparison with calibration value tables can be carried out automatically. In addition, automation can also be used to automatically document a calibration process that has been carried out.

All the features explained and shown in connection with individual embodiments of the invention can be provided in different combinations in the subject-matter according to the invention in order to simultaneously realize their advantageous effects.

All method steps can be implemented by devices that are suitable for executing the respective method step. All functions performed by the features of the subject-matter can be a method step of a method.

The scope of protection of the present invention is given by the claims and is not limited by the features explained in the description or shown in the figures.

### LIST OF REFERENCE SIGNS

100 Dental furnace
103 Detection device
105 Reference body
107 Parameter determination device
109 Holder
111 Firing chamber

1. A dental furnace for sintering dental objects, comprising:
a detection device for detecting a dimension of a sintered reference body; and
a parameter determination device for determining a process parameter for a sintering process on the basis of the detected dimension.

2. The dental furnace according to claim 1,
wherein the detection device comprises a camera or a scanning device.

3. The dental furnace according to claim 1,
wherein the detection device is arranged in such a way that the reference body can be detected inside the dental furnace.

4. The dental furnace according to claim 1,
wherein the detection device is configured to determine a volume of the reference body or a shape of the sintered and/or unsintered reference body.

5. The dental furnace according to claim 1,
wherein the detection device is configured to detect a type of the reference body.

6. The dental furnace according to claim 1,
wherein the detection device is configured to determine the dimension of the unsintered reference body on the basis of a type.

7. The dental furnace according to claim 1,
wherein the detection device is configured to identify whether the reference body is arranged in a predetermined area.

8. The dental furnace according to claim 1,
wherein the parameter determination device is configured to determine the process parameter on the basis of a difference between the dimension of the unsintered reference body and the dimension of the sintered reference body.

9. The dental furnace according to claim 1,
wherein the parameter determination device is configured to determine a process parameter for a temperature, a temperature profile, a duration of the sintering process, a calibration value for a preset process parameter, and/or an air pressure value in the firing chamber.

10. The dental furnace according to claim 1,
wherein the dental furnace comprises a holder for receiving and measuring the reference body.

11. A method of sintering dental objects, comprising the steps of:
detecting a dimension of a sintered reference body by a detection device; and
determining a process parameter for a sintering process on the basis of the detected dimension.

12. The method according to claim 11,
wherein the reference body is cylindrical, annular or cuboidal.

13. The method according to claim 11,
wherein the dimension of the unsintered reference body is detected.

14. The method according to claim 11,
wherein the process parameter is determined on the basis of a difference between the dimension of the unsintered reference body and the dimension of the sintered reference body.

15. The method according to claim 11,
wherein a volume of the reference body or a shape of the sintered and/or unsintered reference body is detected by the detection device.
